(19) United States
(12) Patent Application Publication
(10) Pub. No.: US 2026/0152223 A1
(43) Pub. Date: Jun. 4, 2026

(54) UNDER-ENGINE MUFFLER SYSTEM FOR POWERED SNOW VEHICLES

(71) Applicant: Ruffian Snowbike Corporation, Chester, NH (US)

(72) Inventor: Derek Corey, Chester, NH (US)

(73) Assignee: Ruffian Snowbike Corporation, Chester, NH (US)

(21) Appl. No.: 19/403,622

(22) Filed: Nov. 28, 2025

Related U.S. Application Data
(60) Provisional application No. 63/726,447, filed on Nov. 29, 2024.

(51) Int. Cl. B62B 13/08; B62J 35/00; F01N 13/18

(52) U.S. Cl. CPC B62B 13/08; B62J 35/00; F01N 13/1811

(57) ABSTRACT

A powered snow vehicle is configured as a snow bike or snowmobile and includes a frame, an engine retained by the frame, a track, at least one front ski, and a muffler positioned directly beneath the engine. In one example, the muffler has a rectangular geometry with a downward-directed outlet. The present disclosure is also directed to a steering assembly for a powered snow vehicle, the steering assembly having a steering shaft extending through a head tube and configured to connect to and steer a one-ski assembly or a two-ski assembly, the one-ski assembly being interchangeable by the end user with the two-ski assembly.

### RELATED APPLICATIONS

This application claims the benefit under 35 U.S.C. § 119(e) of U.S. Provisional Patent Application No. 63/726,447 filed on Nov. 29, 2024, and titled POWERED SNOW VEHICLE, the contents of which are incorporated herein by reference in its entirety.

### FIELD OF THE DISCLOSURE

The present disclosure relates generally to motorsports vehicles. Specifically, the present disclosure relates to exhaust configurations, engine component configurations, steering assemblies for winter motorsports vehicles, and to a powered snow vehicle having such features.

### BACKGROUND

Traditional snowmobiles travel over snow using two front steerable skis and a continuous belt or track to the rear. The continuous belt system includes a belt which travels through a tunnel and is supported by a belt frame to provide a large surface area with which to contact snowy surfaces, thereby enhancing traction and propulsion. The continuous belt is powered by an internal engine which is retained within the body of the vehicle. The belt may sometimes have protrusions along the outer circumference in order to better interface with snow and propel the vehicle. Some models, sometimes called “snow bikes,” have only a single front ski.

### SUMMARY OF THE DISCLOSURE

Embodiments of the present disclosure relate generally to improvements in the design of snowmobiles and snow bikes. In one aspect, the present disclosure is directed to a steering assembly for a snow bike having a single ski or a pair of skis. In one embodiment, a steering assembly has a three-tube design with a central tube or head tube that houses a steering shaft. The steering shaft is connected to a steering interface at an upper end (e.g., handlebars) and connected directly or indirectly to a ski or skis at the lower end. In one embodiment, the lower end is connected to tie rods, which transfer rotation of the steering shaft to steer a pair of skis at the front of the vehicle.

In another embodiment, a three-tube steering assembly includes a head tube and two peripheral tubes extending between an upper yoke or bracket and a lower yoke or bracket retaining the peripheral tubes. In one embodiment, the peripheral tubes are part of a respective suspension assembly, which in turn interfaces with a single front ski. A steering shaft extends through the head tube and rotates about a steering axis in response to the operator turning handlebars connected to the steering shaft. Ends of the suspension assemblies connect to a single front ski on the snow vehicle. Thus, moving the handlebars rotates the steering shaft about a steering axis to turn the front ski.

A powered snow vehicle, such as a snow bike, can be adapted to operate with one ski or two skis. In one example embodiment, the two-ski steering assembly can be replaced with a one-ski steering assembly, or vice versa, while retaining the frame and other component systems of the vehicle. A user may therefore equip the vehicle with the preferred design according to preference, weather conditions, or other factors without owning two entirely separate vehicles.

In another aspect, the present disclosure is also directed to arrangements of engine components in snowmobiles and snow bikes. In one embodiment, the frame contains the engine in an engine compartment that is rearward of the steering assembly, and below and in front of the seat. First and second clutches are located below and offset to the left side of the vehicle centerline. The second clutch is laterally between the first clutch and a centerline of the vehicle. The second clutch can be positioned close the centerline C, such as within 5″ (˜12.5 cm) of the centerline C. When the full housing is present surrounding the engine cavity, the second clutch does not exceed the lateral envelope of the frame. This arrangement of clutches being low and close to the centerline lowers the center of gravity of the vehicle, thereby improving balance and maneuverability.

Another aspect of the present disclosure is directed to an exhaust system that is integrated into a snowmobile chassis. The exhaust system includes a low-profile rectangular muffler measuring approximately four inches in thickness and positioned directly beneath the engine. The muffler is shaped to fit between the lower frame rails or belly pan structure while preserving stock ground clearance or improving ground clearance. The under-engine placement centralizes mass and reduces lateral packaging requirements. The muffler is connected to the engine and/or chassis using spring mounts. These mounts allow relative movement between the engine and muffler due to vibration and thermal cycling, commonly used in high-performance snowmobile exhaust systems. Exhaust gases from the engine are routed downward into the muffler. This routing eliminates the need for side-exit exhaust systems that widen the chassis. The system may include curved or straight sections of header tubing, provided that the final routing delivers gases to the under-engine muffler inlet. The muffler includes a downward-facing outlet spout approximately two inches (˜5 cm) in length. The spout is pointed or tapered and directs exhaust gases downward away from the vehicle underbody components, belly pan plastics, and rider. This configuration also helps reduce snow ingestion during deep-snow operation. Positioning of the muffler beneath the engine is configured so that it does not interfere with the CVT system, including the primary clutch, secondary clutch, or belt. Adequate spacing and heat shielding may be used as needed, although no specific shielding is required. Advantageously, eliminating the side-exit muffler and associated wide bodywork enables the snowmobile body panels to be made significantly narrower. This directly reduces side panel drag during sidehill operation and enhances vehicle stability. Additionally, the lower center of gravity improves rider balance and overall handling

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### BRIEF DESCRIPTION OF THE DRAWINGS

FIG. 1 is a side view of a powered snow vehicle having two front skis, in accordance with an embodiment of the present disclosure.

FIG. 2 is a side view of a powered snow vehicle having one front ski, in accordance with an embodiment of the present disclosure.

FIG. 3 is a top and front perspective view showing part of a powered snow vehicle with a steering assembly for one ski, in accordance with an embodiment of the present disclosure.

FIG. 4 is a front perspective and partial sectional view of a powered snow vehicle showing one side of a steering assembly for two front skis, in accordance with an embodiment of the present disclosure.

FIG. 5 is a side view of a powered snow vehicle frame with an engine and exhaust assembly within the frame, in accordance with an embodiment of the present disclosure.

FIG. 6 is a bottom perspective view showing part of a powered snow vehicle, including an engine, an exhaust tube, air intake, and muffler, in accordance with an embodiment of the present disclosure.

FIG. 7 is a top and side perspective view of a powered snow vehicle showing an engine having a starter, a first clutch, and a second clutch arranged nearby the first clutch, in accordance with an embodiment of the present disclosure.

FIG. 8 is a top view of a powered snow vehicle's engine cavity, showing the starter, first clutch, and second clutch, wherein both clutches are located below and offset to the left of as viewed from a rider, in accordance with an embodiment of the present disclosure.

FIG. 9 is a front view of a powered snow vehicle an overall width of the housing, in accordance with an embodiment.

### DETAILED DESCRIPTION

The present disclosure relates generally to an improved steering and control system for a powered snow vehicle. The present disclosure also relates to a snowmobile exhaust system.

In one example embodiment, a steering assembly is provided for a powered snow vehicle, such as a snow bike. The snow vehicle includes a frame defining an open geometry configured to retain an engine, the frame including a front structural member or bulkhead. A head tube is secured to the front structural member of the frame. A first suspension tube on a first side of the head tube has a first suspension assembly movably received in the first suspension tube and extending to a first lower end. A second suspension tube on a second side of the head tube has a second suspension assembly partly received in the second suspension tube and extending to a second lower end. A steering shaft is rotatably received through the central tube, the shaft extending from a first end to a second end.

An upper yoke or bracket is adjacent an upper end of the central tube and defines openings arranged to receive the shaft, the first suspension tube, and the second suspension tube. A lower yoke or bracket is adjacent a lower end of the central tube defines openings to receive the shaft, the first suspension tube, and the second suspension tube. Handlebars are connected to the first end of the shaft so that turning the handlebars rotates the first suspension tube and the second suspension tube about the shaft. A single ski is connected to the first lower end and to the second lower end of the respective suspension assemblies.

In another example embodiment, a head tube is secured to the front structural member or bulkhead of the frame and extends along a steering axis with a steering shaft rotatably received through the head tube, where the steering shaft extends from a first end to a second end. Handlebars are operatively connected to the first end of the steering shaft, such that turning the handlebars rotates the steering shaft about the steering axis. First and second tie rods are operatively connected to the second end of the steering shaft. The first tie rod extends laterally to a first ski on a first side of the frame, and the second tie rod extends laterally to a second ski on a second side of the frame. Rotating the handlebars rotates the steering shaft about the steering axis to steer the first ski and the second ski. The head tube provides support for the bulkhead in some embodiments.

Traditional snowmobiles commonly route exhaust systems laterally to a side-exit muffler mounted beside the engine. This configuration increases the overall width of the vehicle, causing undesirable interaction between the side panel and the snow surface—especially during steep sidehill maneuvers. When the side panel contacts the snow, vehicle stability and rider control are significantly reduced. Additionally, side-mounted mufflers raise the overall center of mass and impose packaging limitations that restrict chassis design, rider ergonomics, and body panel shape. Accordingly, a need exists for a snowmobile exhaust system that enables a narrower body, reduces sidehill panel interference, maintains or improves ground clearance, and does not conflict with existing drivetrain components.

The present disclosure addresses this need and others by providing a snowmobile exhaust system that enables a reduced vehicle width due at least in part to mounting a low-profile muffler beneath the engine rather than exiting laterally. In one example, the exhaust system utilizes a low-profile rectangular muffler mounted in the lower chassis area without reducing ground clearance or interfering with the CVT. Exhaust gases are routed downward from the engine into the muffler, which incorporates a downward-facing pointed outlet spout approximately two inches (˜5 cm) long. This configuration narrows the body panels, lowers the center of gravity, enhances rider ergonomics, and prevents side panel contact with snow during steep sidehill operation.

Numerous variations and embodiments will be apparent in light of the present disclosure.

### Overview

The present disclosure includes at least two different feature sets which may be used individually or in combination to provide a powered snow vehicle with improved flexibility and superior control. The first contributing feature set is a steering system with a steering shaft that rotates about a steering axis to steer a single ski in front of the vehicle or to steer two spaced-apart skis. In one example, the steering system has a head tube that houses the steering shaft. Suspension tubes are retained at sides of the head tube by yokes, where the suspension tubes partly house a shock absorber assembly that extends down to connect to a single, central ski. Rotating the steering shaft by turning handlebars or the like causes the steering assembly to turn the single ski. In another example, the steering shaft connects at its lower end to tie bars, each of which extends laterally to one of two spaced-apart skis. Turning the handlebars rotates the steering shaft about its steering axis and draws the tie bars toward or away from the vehicle centerline to turn the skis on opposite sides of the vehicle.

The central tube may serve to house and protect a steering shaft, which may translate rotational inputs from a steering interface (such as handlebars or a steering wheel) to a tie-bar system located at the lower front end of the shaft. The tie bars may in turn translate rotation from the steering shaft to a pair of skis located on opposite front sides of the vehicle, thus directing the skis and turning the vehicle. Alternatively, two peripheral tubes on sides of the central tube or “head tube” may house portions of respective suspension assemblies. Each suspension assembly connects at its lower end with sides of a single central ski, wherein the steering assembly rotates about the steering shaft to turn the ski to the left or right.

In some embodiments, the suspension tubes and the head tubes are retained by one or more yokes or brackets such that their orientation with respect to each other remains static and so that the suspension assembly can rotate about the steering shaft, which extends along a steering axis. In different configurations, the central and peripheral tubes may house different functions, such as shock forks retained within peripheral tubes. When shock forks are present, they may pivot about the downtube in response to an input of rotational direction by a rider on the steering apparatus. Tubes designed for shock forks may be made intentionally narrow - only wide enough to house the shock forks, in order to prevent snow from blowing back into the tubes. These functions may function differently to enable operation for a one-ski or a two-ski arrangement, and in some embodiments the functions may be constructed such that a steering assembly fitted for and having one ski may be replaced with a steering assembly fitted for and having two skis.

In one embodiment, the switch may be accomplished by utilizing a central tube or “head tube” for one-ski operation and two-ski operation. In such embodiments, the central tube designed for two-ski operation may have tie-rod connectors at one end, while a central tube is welded to the frame. The steering shaft extends through the central tube and can be used to steer a single ski via the suspension assemblies connected to that ski. For the two-ski steering system, a plate is bolted to the bottom of the steering tube and connects to tie rods extending laterally to skis on opposite sides of the steering assembly. The right and left shock absorber assemblies can be removed when modifying the steering assembly from a one-ski steering assembly to a two-ski steering assembly.

Another contributing feature set is a particular selection and arrangement of major function components within the engine cavity to enable a smaller-volume engine cavity and more narrow vehicle profile. In some embodiments, the snow vehicle includes an engine cavity defined by a frame having a hollow space forward of the seat and below than the steering interface (e.g., handlebars). In some configurations, the cavity may be straddled by a rider in the seat, which an arrangement of heavy parts between the rider's knees. The vehicle includes an engine mounted in the engine cavity, which may be a two-stroke engine, and which is positioned rearward of the steering assembly and as low as possible relative to the rest of the vehicle so as to lower the vehicle's center of gravity. Such a lowered center of gravity is beneficial because it improves the stability of the vehicle in motion and the responsiveness of the steering. In one embodiment, the engine's major rotating assembly and/or arrangement of heavy parts is located beneath the topline of the continuous belt. The main mass of heavy parts being rearward of the handlebars, and thus closer to the center of the vehicle, also allows improved steering control by lowering the necessary turning radius, lending a ‘flickable’ or quick and responsive quality to the riding experience.

In addition to vertical and horizontal positioning, the major components of the engine cavity are also arranged to create a narrower width than is otherwise available on powered snow vehicles. Depending on the arrangement, the engine cavity may be designed such that a rider's legs rest against sides of the frame, straddling the engine cavity. In some arrangements, the engine may be approximately positioned between the rider's knees or thighs. In some embodiments, the rider's knees, when pressed against the frame of the vehicle, may be less than 17 inches apart, such as in a range from 13-17 inches apart. In some configurations, the vehicle may include a foot shield to protect a rider's lower leg from snow or other debris.

The compact nature of the engine cavity design also has the benefit of harvesting radiant heat from the engine during operation to address running issues common in motorized snow vehicles. As one benefit, two-stroke expansion pipes require some radiant heat to operate properly, which is particularly beneficial when operating snowmobiles and other motorized vehicles in sub-freezing temperatures. Some end users currently wrap the pipes or add insulation to preserve heat. According to embodiments of the present disclosure, enclosing the pipe within the engine compartment allows radiant heat produced by the engine to aid in the operation of the expansion pipe.

As another benefit, the engine air intake is arranged so that incoming air travels for some distance within the engine compartment, thereby providing space to heat the incoming air prior to entering the engine. This helps address issues from intaking sub-freezing air, such as carburetor icing or reduced engine performance compared to intaking warmer air.

The engine cavity may also include a muffler, and in one embodiment, the muffler has a pancake or low-profile design. For example, the muffler is located at the bottom of the engine cavity and configured to vent exhaust downward. Venting the exhaust downward allows for greater ground clearance, and positioning the muffler at the bottom of the engine cavity allows for a narrower profile of the snow bike, further contributing to the ‘flickability’ or maneuverability of the vehicle.

### Example Embodiments

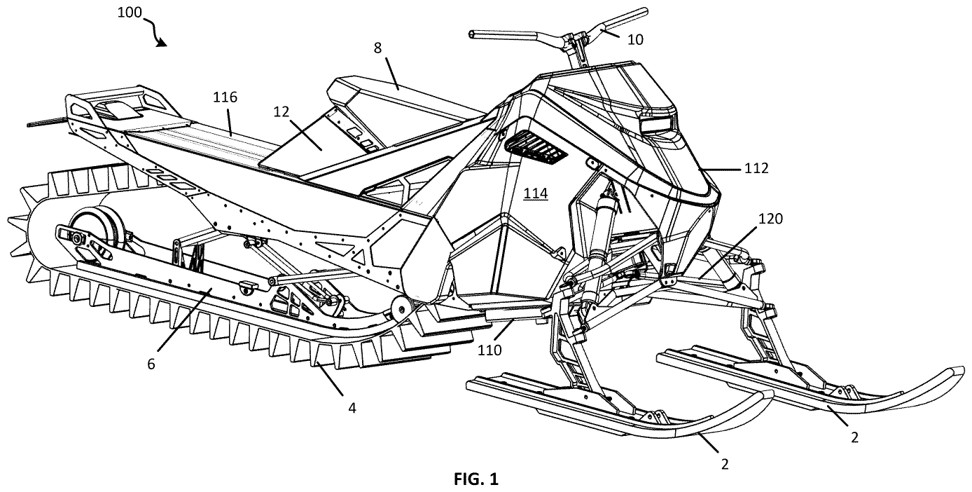

FIG. 1 is a side view of a snow vehicle 100 comprising a frame 110 having a housing 112, an engine cavity 114 defined by the frame 112, and a tunnel 116. The vehicle 100 has two front skis 2 and also includes a continuous belt 4 supported by a frame 6. The continuous belt 4 is arranged to rotate around the frame 6 such that it travels through the tunnel 116 and down to contact a snowy or icy surface below the vehicle. A rider may sit on the seat 8, straddling the vehicle and directing it in operation with the steering interface 10 (e.g., handlebars). A fuel tank 12 is below the seat 8 and is positioned behind the engine cavity 114. The proximity of the fuel tank 12 to the engine cavity 114 serves to channel some of the radiant heat produced by the interior of the engine cavity 114 to minimize fuel gelling in cold temperatures. Additionally, the fuel tank 12 can have a triangular profile as viewed from the side in FIG. 1, which both serves to improve the snow vehicle's 100 aerodynamics and reduce fuel sloshing during operation.

Right and left skis are each connected to the chassis 110 via a tie bar system 120, which extends into the housing 112 and serves to couple each individual ski 2 with the steering interface 10. The engine cavity 114 is located rearward of the skis 2 and the steering interface 10 and may be substantially straddled by a rider occupying seat 8. The housing 112 may be pointed or nose-shaped as shown to better enable the vehicle 100 to navigate through deeper snow conditions. Similarly, the steering interface 10 may be positioned relative to the height of the seat 8; in some instances, the seat 8 may be low while the handlebars are relatively higher, for example, 15-30 cm of vertical space may separate the top of the seat from the steering interface.

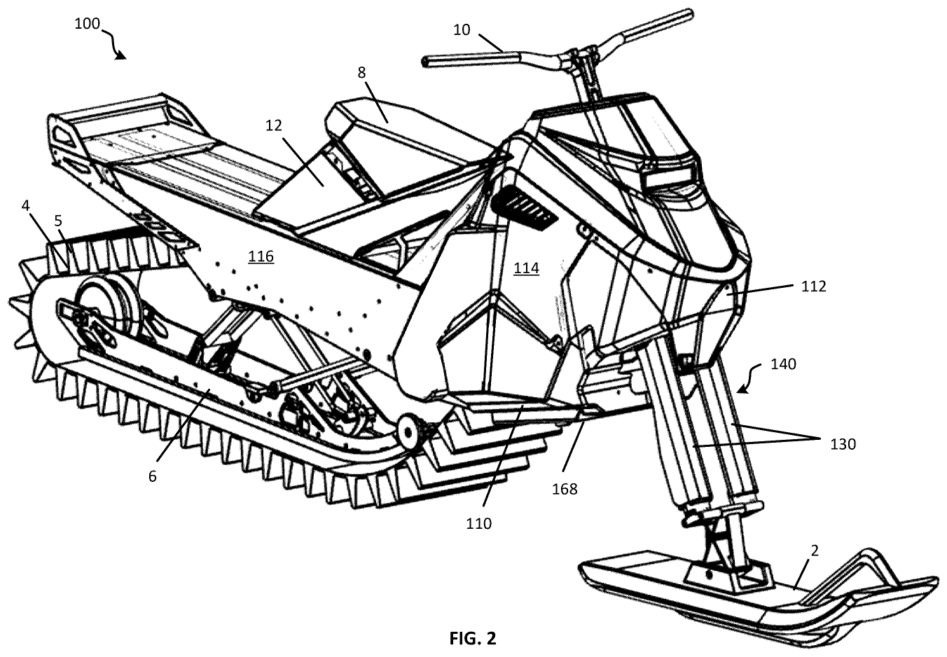

FIG. 2 is a side view of a snow vehicle 100 comprising a chassis 110, a housing 112, an engine cavity 114, and a tunnel 116. The vehicle 100 has a single front ski 2 and also includes a continuous belt 4 having a plurality of snow-engaging elements 5. The belt 4 is supported by a belt suspension frame 6. The continuous belt 4 is arranged to route around the frame 6 such that it travels through the tunnel 116 and down to contact a snowy or icy surface below the vehicle. A rider may sit on the seat 8 and direct the vehicle in operation with the steering interface 10. Below the seat 8 is a fuel tank 12, which is positioned rearward of the engine cavity 114.

The single ski 2 is connected to the frame 110 via two suspension tubes 130, each of which extends into the housing 112 and couples the ski 2 with the steering interface 10. The engine cavity 114 is located rearward of the steering assembly 140 and the steering interface 10. In use, a rider sitting on the seat 8 can straddle the fuel tank 12 with knees extending forward around the sides of the engine cavity 114. The housing 112 may be pointed or rounded to better enable the vehicle 100 to navigate through deeper snow. The housing 112 defines an opening to accommodate the steering assembly 140.

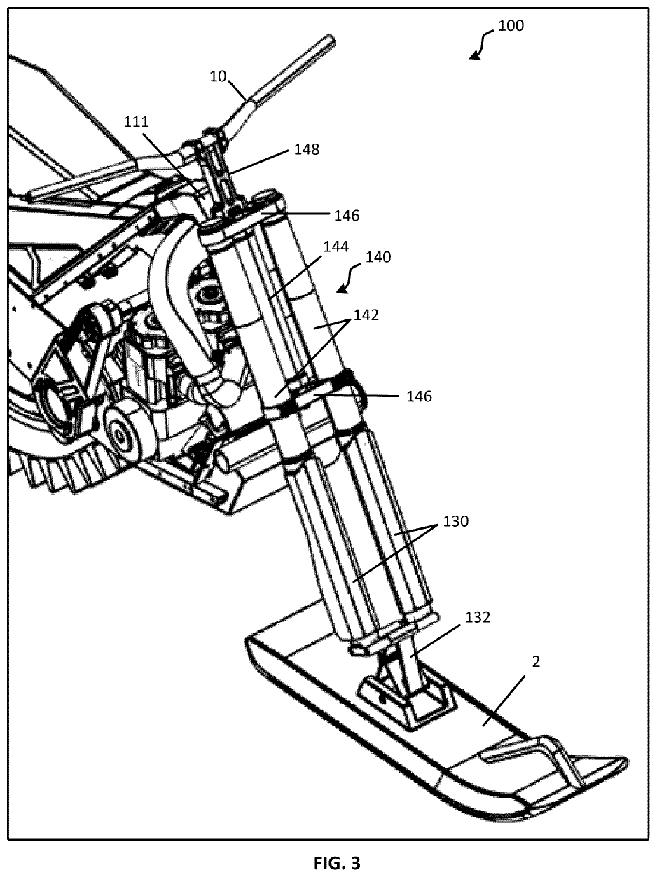

FIG. 3 is a top and front perspective view showing part of a snow vehicle 100. The steering assembly 140 has a steering interface 10 for a single ski 2 and connects the steering interface 10 to the ski 2 with two peripheral tubes 142 on opposite sides of a central tube 144 (or “head tube”) that houses the steering shaft 148. Suspension tubes 130 extend upward into two peripheral tubes 142, which are part of the steering assembly 140. The steering assembly 140 also includes one or more yokes 146 or brackets that hold the central tube 144 and the peripheral tubes 142 at a fixed arrangement relative to each other.

In a one-ski arrangement, the central tube 144 is fixed to the front of the chassis 110. The bulkhead 111 can be secured to the central tube 144. Rotating the steering interface 10 pivots the peripheral tubes 142, and therefore the ski 2, about the steering shaft 148. The central tube 144 extends between upper and lower yokes 146, and may be retained entirely within the housing 112. In some embodiments, the central tube 144 has a length of 12-14″ in length (30-35 cm), although the central tube 144 can have any length and any shape, including round, square, and octagonal. The peripheral tubes 142 thus pivot about the steering axis and transfer that movement to a connection 132 on the ski 2. Rotating the suspension shafts 130 about the steering axis turns the ski 2. In some embodiments, the connection point 132 is a pivot connection with the ski 2, allowing the ski 2 to pivot up and down as the ski travels over the ground. In some embodiments, the central tube 144 includes bearing(s) at the first end and at the second end to facilitate rotation of the steering shaft 148, which extends through the central tube and is rotatable about the steering axis A.

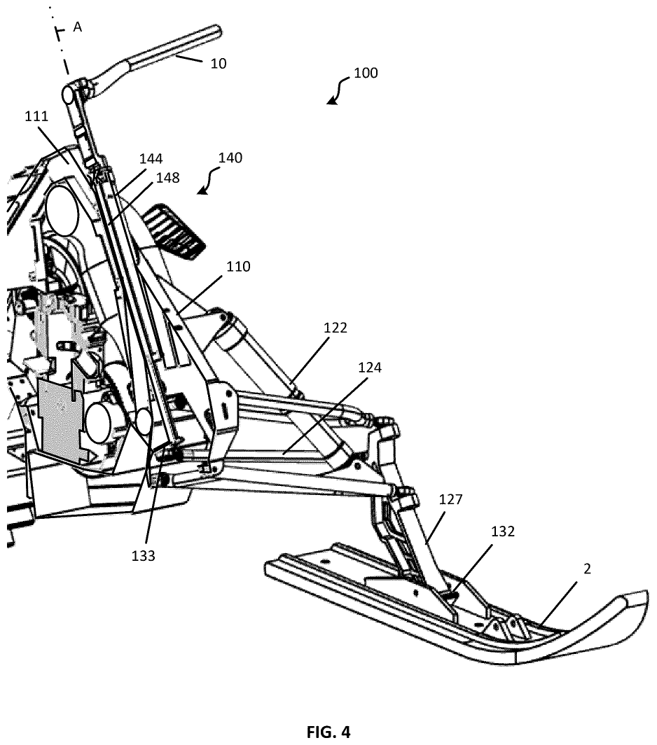

FIG. 4 is a sectional view showing part of a steering assembly 140 for a powered snow vehicle 100 having two front skis 2. FIG. 4 shows only one ski 2 and one tie bar 120, and it will be apparent in light of the specification that this setup will be mirrored on the other side of the vehicle 100. The ski 2 is pivotably connected to the frame by a shock absorber 122 and ski brackets 124 that extend laterally from the frame to a body 127 that extends upward from and is pivotably connected to the ski 2. The ski 2 thus is capable of vertical movement in response to variations in terrain. The shock absorber 122 serves to absorb vibration when the ski 2 encounters terrain in motion, which improves the comfort of the rider. In some embodiments, the frame is configured as a frame for a dirt bike.

Components of a steering assembly 140 are also shown. In this example embodiment, the steering system 140 includes a central tube 144 housing a steering shaft 148 connected to a steering interface 10 (e.g., handlebars) at a first (top) end and to a tie bar connector 132 at a second (lower) end. The steering assembly 140 serves to steer a two-ski snow vehicle 100 by translating user-input rotational direction on the steering interface 10 to rotational movement of the steering shaft 148. The tie bar system 120 interfaces with the steering assembly 140 via the tie bars 124. Each tie bar 124 is operatively coupled to the steering shaft 148 and extends laterally to the ski bracket. When the steering shaft 148 is rotated about the steering axis A by turning the steering interface 10 (e.g., handlebars), this rotation moves the steering knuckle 133 to move each tie bar 120 inward or outward. The steering knuckle 133 can be, for example, a plate, bracket, or other component secured to the lower end of the steering shaft 148 so that ends of respective tie bar 124 attach to the steering knuckle 133 and are responsive to rotation of the steering shaft 148 to steer the vehicle. The inward or outward movement of the tie bar 124 acts on the ski bracket to turn the ski 2. In some embodiments, the connection point 132 may be a free-rotating connection point, allowing the ski 2 to point up or down to interface with terrain. The central tube 144 is connected to and provides support to the bulkhead 111.

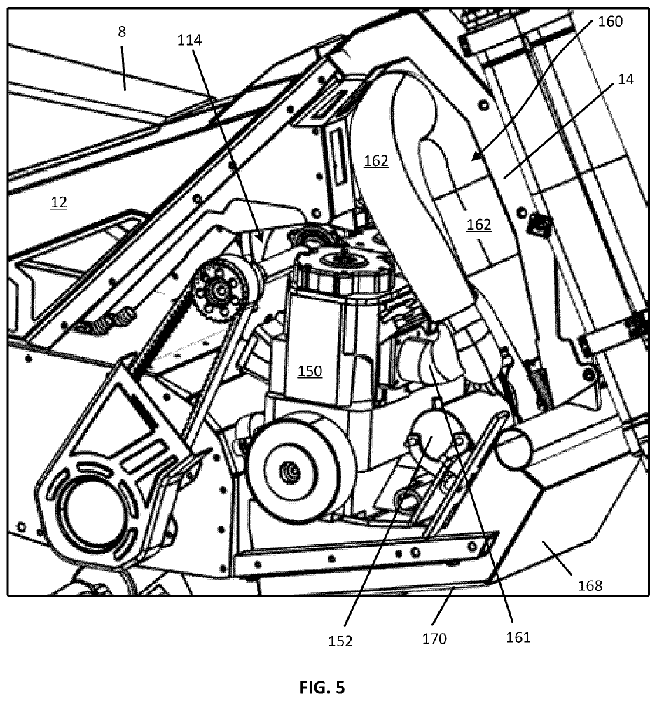

FIG. 5 is a side view showing an engine compartment of a powered snow vehicle 100, in accordance with an embodiment of the present disclosure. In this example, the engine 150 and an exhaust system 160 are retained in majority part or completely within the engine cavity 114 defined by the frame 14. The engine 150 is positioned low within the engine cavity 114 and is positioned rearward of the steering assembly 140. In some embodiments, the engine 150 may be a 2-stroke or 4-stroke combustion engine, for example.

In operation, the engine 150 produces radiant heat, which is absorbed by the other components in and around the engine cavity 114 to various operational benefits. As one benefit, the exhaust system 160 may have an expansion chamber 162 in order to regulate power output from the engine 150. Operation in sub-freezing temperatures can impact the effectiveness of expansion chambers, but positioning components of the exhaust system 160, including the exhaust tube or expansion chamber 162, inside the engine cavity 114 can help mitigate this issue by keeping the expansion chamber 162 above freezing, even when operating in cold temperatures. As shown in this example, the expansion chamber 162 connects to the collection pipe 161 and wraps up and around the engine 150 within the frame 14 and then extends down to a flattened exhaust muffler 168 that is positioned below the engine 150 and adjacent the belly pan 170. The proximity of the expansion chamber 162 to the engine 150 transfers heat from the engine 150 to the exhaust components.

As another benefit, the fuel tank 12 is positioned above and behind the engine cavity 114. Fuel of the kind commonly used in motorsports vehicles can become gelatinous if allowed to get too cold. Positioning the fuel tank 12 near the engine cavity 114 can reduce the risk of fuel gelling when operating a motorsports vehicle in sub-freezing temperatures. As can be seen in FIG. 5, the triangular-shaped fuel tank 12 is located between the seat 8 and the engine cavity 112.

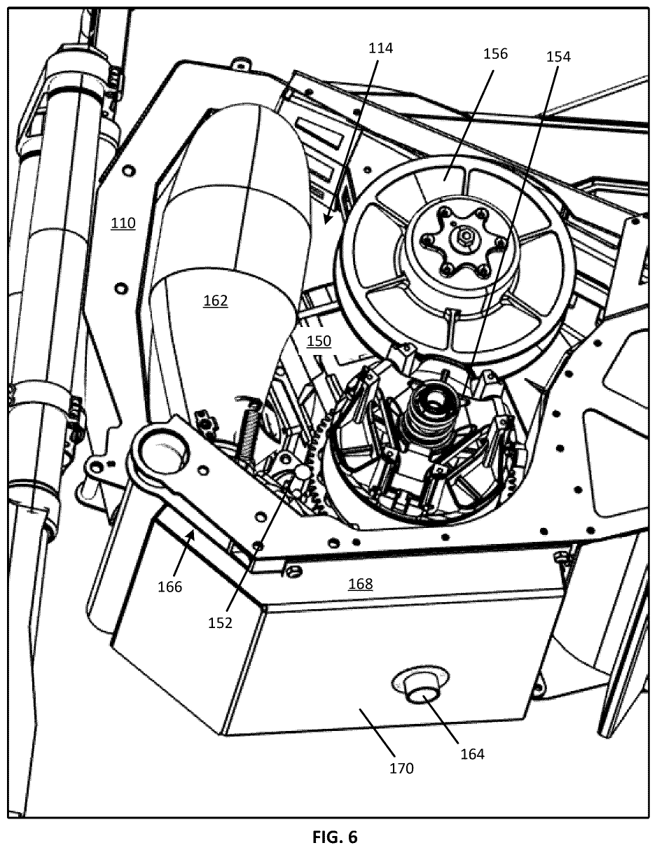

FIG. 6 is a bottom, perspective view of a powered snow vehicle's engine cavity 114, in accordance with an embodiment of the present disclosure. In this example, the housing is illustrated as transparent to better show the exhaust tube 162, exhaust outlet 164, exhaust inlet 166, and muffler 168, which are each positioned within or proximal to the engine cavity 114 and thereby kept warm by heat of the engine 150 in operation. The exhaust expansion tube 162 connects to the exhaust inlet 166 via an elbow connector or other suitable connector (not shown). The exhaust components can take advantage of radiant heat produced by the engine 150 during operation due to their proximity. Locating the air intake within the engine cavity and including a space within the air intake for air to warm before entering the engine 150 can reduce or eliminate issues such as carburetor icing that can occur from intaking sub-freezing air.

In addition to being kept warm by its proximity to the engine 150, the exhaust system 160 is also configured to vent exhaust through a flattened muffler 168, sometimes referred to as a pancake muffler, located directly beneath the engine 150 and central to the chassis 110. In some embodiments, the muffler 168 may be flattened or have some other low-profile so it can be positioned below the engine. In one embodiment, the muffler is a low-profile rectangular unit approximately four inches thick, designed to fit in the lower central chassis area without reducing ground clearance or interfering with the transmission or belt-drive components. The muffler 168 can include an exhaust outlet 164 which vents exhaust downward through the belly pan 170 (illustrated as transparent here), such that it encounters the air in the ground clearance between the vehicle and the terrain. Such a configuration has the benefit of narrowing the profile of the vehicle 100.

The exhaust header 160 is routed downward from the engine 150 into the under-engine muffler 168, which is secured using spring-mounting to accommodate engine movement, vibration, and thermal expansion. The muffler features a downward-facing pointed exhaust outlet 164, configured as a spout of approximately two inches (˜5 cm) in length. The exhaust outlet 164 directs hot gases away from surrounding components while reducing snow ingestion. Advantageously, locating the muffler centrally lowers the center of gravity, significantly narrows the body panels, and improves ride ergonomics and sidehill handling by eliminating excessive panel-to-snow contact.

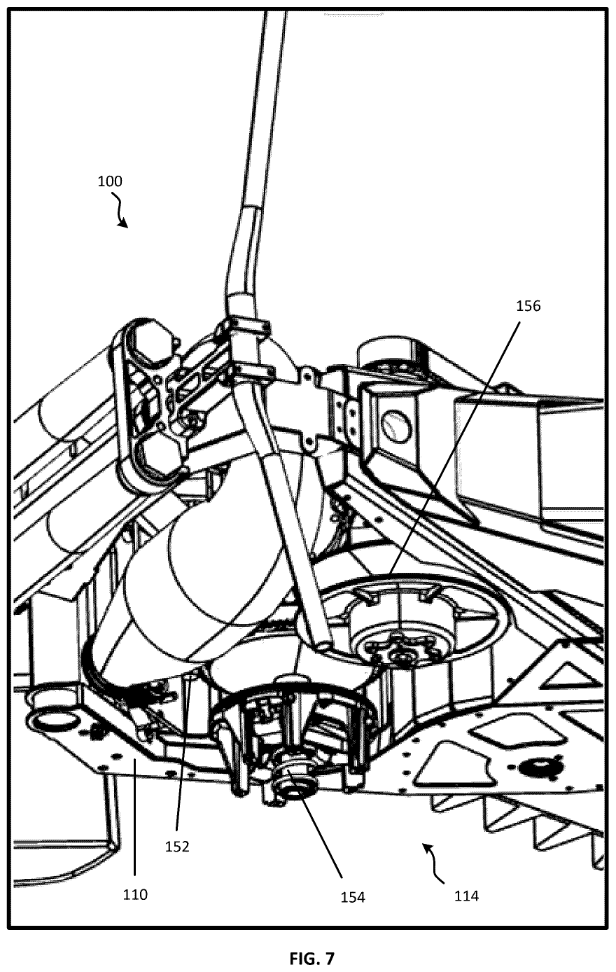

FIG. 7 is a top and side perspective view showing part of a powered snow vehicle 100 and its engine cavity 114, which contains a starter motor 152 (also shown in FIG. 6), a first clutch 154 (or starter clutch), and a second clutch 156 (or drive clutch), in accordance with an embodiment of the present disclosure. Note that the housing and other components are not shown here for clarity. Each of the components is located such that they may be interfaced with by a rider through the chassis 110. The external surface of the first clutch 154 and the second clutch 156 are located nearby to each other. For example, the rotational center of the first clutch 154 and the rotational center of the second clutch 156 can be spaced by 9-12 inches (20-30 cm). This compact design helps minimize the profile of the vehicle 100 and allows a rider to interact with the functions easily from the seat.

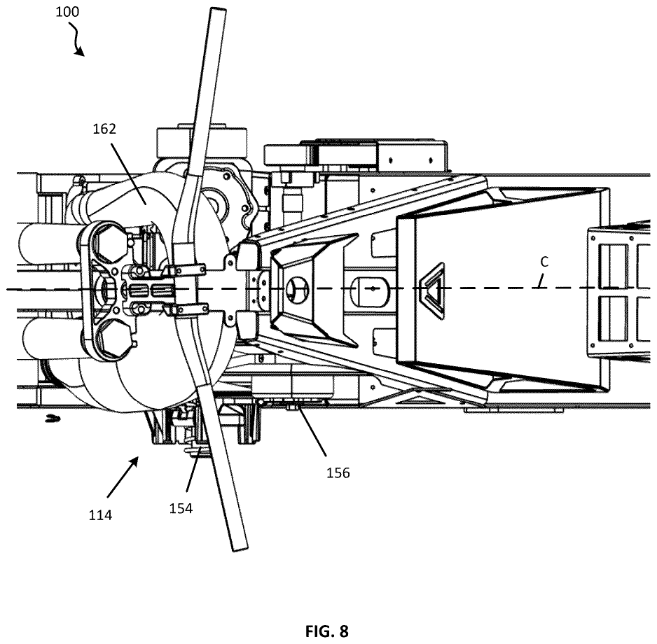

FIG. 8 is a top view of a powered snow vehicle 100 and shows the first clutch 154 and second clutch 156, wherein both clutches 154, 156 are located below and offset to the left side of the vehicle centerline C. The seat, fuel tank, and other components are omitted for clarity. As can be seen, the second clutch 156 is laterally between the first clutch 154 and a centerline of the vehicle. The second clutch 156 may be close the centerline C, and in one embodiment is within 5″ (˜12.5 cm) of the centerline C. When the full frame 14 is present surrounding the engine cavity 114, the second clutch 156 does not exceed the lateral envelope of the frame 14. This arrangement of clutches 154, 156 being low and close to the centerline C serves to lower the center of gravity of the vehicle 100, improving balance and maneuverability. As an additional benefit, this arrangement allows for a rider's knee to rest nearby the vehicle without impairing a rider's ability to access functions of the vehicle. When a rider is properly seated on the seat 8, the engine cavity 114, first clutch 154, and second clutch 156 are positioned below the rider.

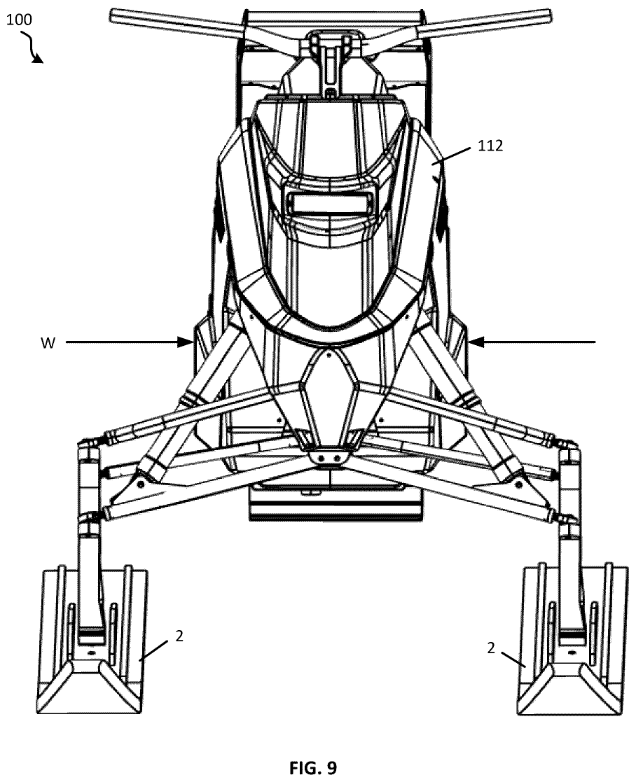

FIG. 9 is a front view of a powered snow vehicle with the housing 112, in accordance with an embodiment. Due to the arrangement of engine and exhaust components, the overall width W, measured at the outside surfaces of the housing 112 or the lateral extent of any engine and exhaust components, is not more than 25 inches (63.5 cm), preferably not more than 22 inches (˜56 cm), and more preferably not more than 20 inches (˜51 cm). This dimension can be achieved regardless of whether the powered snow vehicle 100 has a single front ski 2 or two skis 2. This reduced overall width W contributes to the improved handling and maneuverability of the powered snow vehicle as well as improved rider comfort.

### Further Example Embodiments

The following examples pertain to further embodiments, from which numerous permutations and configurations will be apparent.

Example 1 is a powered snow vehicle that includes a frame, an engine retained by the frame, a track, at least one front ski, and a muffler positioned directly beneath the engine. The powered snow vehicle can be a snowmobile or snow bike, for example.

Example 2 includes the powered snow vehicle of Example 1, where the muffler defines a downward-directed outlet.

Example 3 includes the powered snow vehicle of Example 2, wherein the muffler connects to an exhaust tube located in front of the engine.

Example 4 includes the powered snow vehicle of Example 3 and includes springs between the muffler and the exhaust tube, the springs tensioned to draw the exhaust tube toward the muffler.

Example 5 includes the powered snow vehicle of Example 3, where the exhaust tube connects to a forward-positioned engine outlet, wraps up and over a front part of the engine, and then extends downward to the muffler.

Example 6 includes the powered snow vehicle of any one of Examples 1-5, where the muffler includes a rectangular box shape.

Example 7 includes the powered snow vehicle of Example 6, wherein the rectangular box shape of the muffler has a vertical thickness of not more than 12.7 cm.

Example 8 includes the powered snow vehicle of Example 7, wherein the vertical thickness is not more than 10 cm.

Example 9 includes the powered snow vehicle of any one of Examples 1-8, wherein the outlet has a length of not more than 6 cm.

Example 10 is a powered snow vehicle having a frame defining an open geometry configured to retain an engine, the frame including a front structural member. A steering assembly includes a head tube secured to the front structural member of the frame, a first suspension tube on a first side of the head tube, a second suspension tube on a second side of the head tube, a steering shaft rotatably received through the central tube, the steering shaft extending from an upper end to a lower end, an upper bracket on an upper end of the central tube and defining openings arranged to receive the shaft, the first suspension tube, and the second suspension tube, and a lower bracket adjacent a lower end of the central tube, the lower bracket spaced vertically from the upper bracket and defining openings to receive the shaft, the first suspension tube, and the second suspension tube. Handlebars are operatively connected to the upper end of the steering shaft. A muffler is below the engine.

Example 11 includes the powered snow vehicle of Example 10 and further includes a single ski operatively connected to the steering assembly.

Example 12 includes the powered snow vehicle of Example 10 and further includes a first ski on a first side of the steering shaft and a second ski on a second side of the steering shaft.

Example 13 is a steering assembly for a powered snow vehicle, the steering assembly including a frame having an open geometry with a front structural member, the frame defining an engine compartment configured to retain an engine. A head tube is secured to the front structural member of the frame and extends along a steering axis. A steering shaft is rotatably received through the head tube and extends from a first end to a second end. Handlebars are operatively connected to the first end of the steering shaft, where turning the handlebars rotates the steering shaft about the steering axis. A steering knuckle is on the second end of the steering shaft. A first tie rod is operatively connected to the steering knuckle and a second tie rod is operatively connected to the steering knuckle. A first ski is on a first side of the frame and is connected to the first tie rod. A second ski is on a second side of the frame and is connected to the second tie rod. Rotating the handlebars rotates the steering shaft about the steering axis to steer the first ski and the second ski.

Example 14 is a snow bike comprising the steering assembly of Example 13.

Example 15 includes the snow bike of Example 14 and includes an engine retained in the engine compartment, a fuel tank rearward of the engine compartment, and a seat above the fuel tank.

Example 16 includes the snow bike of Example 15, wherein the fuel tank has a triangular profile.

Example 17 includes the snow bike of any one of Examples 14-16, where the engine is behind the steering assembly.

Example 18 includes the snow bike of any one of Examples 14-17 and includes an exhaust expansion tube between the engine and the steering assembly.

Example 19 includes the snow bike of Example 18 and has a muffler below the engine, where the exhaust expansion tube is connected to the muffler.

Example 20 includes the snow bike of Example 19, wherein the muffler defines a downward-directed outlet.

Example 21 is a method of changing a steering mode on a powered snow vehicle, the method comprising providing a vehicle having handlebars operatively coupled to a steering shaft at a first end, wherein the steering shaft is disposed within a central tube and operatively coupled to a single ski at a second end; removing the single ski coupled to the second end of the steering shaft; connecting a first tie bar to the second end and to a first ski on a first side of the powered snow vehicle; and connecting a second tie bar to the second end and to a second ski on an opposite second side of the powered snow vehicle, wherein the first tie bar and the second tie bar are configured to translate directional input from the handlebars to the first ski and the second ski via the steering shaft.

Example 22 includes the method of Example 21 and further includes attaching a steering plate to the second end of the steering shaft, connecting the first tie bar to a first side of the steering plate, and connecting the second tie bar to a second side of the steering plate

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1. A powered snow vehicle comprising:
a frame defining an engine compartment;
an engine retained in the engine compartment;
a track;
at least one front ski; and
a muffler positioned directly beneath the engine.

2. The powered snow vehicle of claim 1, wherein the muffler defines a downward-directed outlet.

3. The powered snow vehicle of claim 2, wherein a top of the muffler connects to an exhaust tube located in front of the engine.

4. The powered snow vehicle of claim 3, comprising springs between the muffler and the exhaust tube, the springs tensioned to draw the exhaust tube toward the muffler.

5. The powered snow vehicle of claim 3, wherein the exhaust tube connects to a forward-positioned engine outlet, wraps up and over a front part of the engine, and then extends downward to the muffler.

6. The powered snow vehicle of claim 1, wherein the muffler has a rectangular shape.

7. The powered snow vehicle of claim 6, wherein the muffler has a vertical thickness of not more than 12.7 cm.

8. The powered snow vehicle of claim 7, wherein the vertical thickness is not more than 10 cm.

9. The powered snow vehicle of claim 1, wherein the at least one front ski one of a single ski assembly and a two-ski assembly having left and right skis, wherein each of the single ski assembly and the two-ski assembly are compatible with the steering assembly and configured to be interchangeable by an end-user.

10. The powered snow vehicle of claim 1 comprising:
a steering assembly having:
a head tube secured to the front structural member of the frame and extending along a steering axis;
a steering shaft rotatably received through the head tube, the steering shaft extending from a first end to a second end;
handlebars are operatively connected to the first end of the steering shaft, wherein turning the handlebars rotates the steering shaft about the steering axis;
a steering knuckle on the second end of the steering shaft;
a first tie rod operatively connected to the steering knuckle;
a second tie rod operatively connected to the steering knuckle;
a first ski on a first side of the frame, the first ski connected to the first tie rod; and
a second ski on a second side of the frame, the second ski connected to the second tie rod;
wherein rotating the handlebars rotates the steering shaft about the steering axis to steer the first ski and the second ski.

11. The powered snow vehicle of claim 1, comprising:
a fuel tank rearward of the engine compartment; and
a seat above the fuel tank.

12. The snow bike of claim 11, wherein the fuel tank has a triangular profile.

13. The snow bike of claim 11, wherein the engine is behind the steering assembly.

14. The snow bike of claim 13, comprising an exhaust expansion tube between the engine and the steering assembly.

15. The snow bike of claim 11, comprising a muffler below the engine, the exhaust expansion tube connected to the muffler.

16. The snow bike of claim 15, wherein the muffler defines a downward-directed outlet.

17. A method of changing a steering mode on a powered snow vehicle, the method comprising:
providing a vehicle having handlebars operatively coupled to a steering shaft at a first end, wherein the steering shaft is disposed within a head tube and operatively coupled to a single ski at a second end;
removing the single ski coupled to the second end of the steering shaft;
connecting a first tie bar to the second end and to a first ski on a first side of the powered snow vehicle; and
connecting a second tie bar to the second end and to a second ski on an opposite second side of the powered snow vehicle, wherein the first tie bar and the second tie bar are configured to translate directional input from the handlebars to the first ski and the second ski via the steering shaft.

18. The method of claim 17, comprising:
providing a steering knuckle on the second end of the steering shaft;
connecting the first tie bar to a first side of the steering knuckle; and
connecting the second tie bar to a second side of the steering knuckle.
